(19) United States
(12) Patent Application Publication
(10) Pub. No.: US 2017/0345175 A1
(43) Pub. Date: Nov. 30, 2017

(54) DEPTH EXTRACTING METHOD AND DEPTH EXTRACING CAMERA SYSTEM USING FOCUSE MEASURE RATIO

(71) Applicant: CENTER FOR INTEGRATED SMART SENSONS FOUNDATION, Yuseong-gu (KR)

(72) Inventors: Dong Suk KIM, Gunpo-si (KR); Sang Gil CHOI, Yongin-si (KR); Young Ki KIM, Seo-gu (KR)

(21) Appl. No.: 15/602,145

(22) Filed: May 23, 2017

(30) Foreign Application Priority Data
May 26, 2016 (KR) 10-2016-0064675

(51) Int. Cl. G06T 7/571; G06T 7/33; G06T 3/00

(52) U.S. Cl. CPC G06T 7/571; G06T 3/0068; G06T 7/337; G06T 2207/10016

(57) ABSTRACT

Disclosed is a depth extracting method using a focus measure ratio in a depth extracting camera system including acquiring a plurality of images—each of the plurality of images including a subject—having different focused subject distances; calculating a focus measure ratio between the plurality of images; and extracting depth for the subject based on the focus measure ratio between the plurality of images.

This application claims the priority benefit of Korean Patent Application No. 10-2016-0064675, filed on May 26, 2016, in the Korean Intellectual Property Office, the disclosure of which is incorporated herein by reference.

### BACKGROUND

### 1. Field of the Invention

The following example embodiments relate to a depth extracting camera system and a depth extracting method of the depth extracting camera system, and more particularly, to technology extracting depth for a subject by using a focus measure ratio.

### 2. Description of the Related Art

An existing technology of extracting depth for a subject is classified into an active type and a passive type depending on whether a subject is irradiated with light.

The active type depth extracting methods are a TOF (Time of flight) method measuring the time the light returning after irradiating a laser to a subject, a triangulation-based method using the reach to other position of a sensor depending on the depth of the laser irradiated to a subject, a white light method extracting depth by examining line or grid pattern on a subject and identifying a modified form, and a structured light method extracting depth information with the triangulation-based method by irradiating structured light encoded with information and identifying the structured light by sensor.

Although a camera system using such the active type depth extracting methods shows high accuracy, there are disadvantages in that the manufacturing cost is high, the use is restricted outdoors, the use distance is limited, and the structure is difficult to miniaturize.

The passive type depth extracting methods are typically a depth from stereo method extracting depth from parallax between images acquired from at least two or more camera devices, a structure from motion method extracting depth from motion parallax between a plurality of images acquired from one camera system, and a method extracting depth based on a blur size change between two images acquired based on different optical signals.

Such the passive type depth extracting methods have advantages in that the limitation in the use environment is low and the manufacturing cost is low, but they have disadvantages in that there are limitations in the processing speed and accuracy.

Accordingly, the following example embodiments propose a technology extracting depth for a subject by using a focus measure ratio for overcoming the disadvantages of the existing depth extracting method.

### SUMMARY

At least one example embodiment provides a depth extracting method and a depth extracting camera system extracting depth for a subject by using a focus measure ratio between a plurality of images having different focused subject distances.

At least one example embodiment also provides a depth extracting method and a depth extracting camera system calculating a focus measure ratio between a plurality of images to distinguish far-near of the focused subject distance of each of the plurality of images in order to use the focus measure ratio between the plurality of images in a depth extracting process.

At least one example embodiment also provides a depth extracting method and a depth extracting camera system aligning a plurality of images by performing software image processing in a process of calculating a focus measure ratio between a plurality of images.

A least one example embodiment also provides a depth extracting method and a depth extracting camera system creating a depth map in a video by acquiring sequentially a plurality of images with a video frame unit and extracting depth for a subject with the video frame unit.

According to an aspect of at least one example embodiment, there is provided a depth extracting method using a focus measure ratio in a depth extracting camera system comprising acquiring a plurality of images—each of images including a subject—having different focused subject distances; calculating a focus measure ratio between the plurality of images; and extracting depth for the subject based on the focus measure ratio between the plurality of images.

The calculating a focus measure ratio may be configured to calculate a focus measure ratio between the plurality of images to distinguish far-near of the focused subject distance of each of the plurality of images.

The calculating a focus measure ratio may be configured to calculate a focus measure ratio between the plurality of images to a value of between 0 to 2 to distinguish far-near of the focused subject distance of each of the plurality of images.

The extracting depth for the subject based on the focus measure ratio between the plurality of images may be configured to extract depth for the subject based on the focus measure ratio between the plurality of images reflected the far-near of the focused subject distance of each of the plurality of images.

The calculating a focus measure ratio between the plurality of images may comprise aligning the plurality of images based on an alignment parameter; and calculating a focus measure ratio between the aligned plurality of images.

The alignment parameter may be configured to be estimated based on a result of matching at least two or more images having different subject distances of the depth extracting camera system.

The calculating a focus measure ratio between the plurality of images may comprise measuring focus measures of each of the plurality of images; and calculating a focus measure ratio between the plurality of images based on the focus measures of each of the plurality of images.

The acquiring a plurality of images having different focused subject distances may comprise acquiring sequentially the plurality of images with a video frame unit of the depth extracting camera system, and the extracting depth for the subject based on the focus measure ratio between the plurality of images may comprise extracting depth for the subject with the video frame unit.

According to example embodiments, a depth extracting camera system using a focus measure ratio may comprise an image sensor acquiring a plurality of images—each of the plurality of images including a subject—having different focused subject distances; and a depth extracting unit calculating a focus measure ratio between the plurality of images and extracting depth for the subject based on the focus measure ratio between the plurality of images.

The depth extracting unit may be configured to calculate a focus measure ratio between the plurality of images to distinguish far-near of the focused subject distance of each of the plurality of images.

The depth extracting unit may be configured to align the plurality of images based on an alignment parameter and calculate a focus measure ratio between the aligned plurality of images.

The image sensor may be configured to acquire sequentially the plurality of images with a video frame unit of the depth extracting camera system, and the depth extracting unit may be configured to extract depth for the subject with the video frame unit.

According to example embodiments, there may be provided a depth extracting method and a depth extracting camera system extracting a subject by using a focus measure ratio between a plurality of images having different focused subject distances.

Also, according to example embodiments, there may be provided a depth extracting method and a depth extracting camera system calculating a focus measure ratio between a plurality of images to distinguish far-near of the focused subject distance of each of the plurality of images in order to use the focus measure ratio between the plurality of images in a depth extracting process.

Also, according to example embodiments, there may be provided a depth extracting method and a depth extracting camera system reducing a complexity of a depth extracting calculation and improving an accuracy of depth extracting compared to the existing depth extracting method.

Also, according to example embodiments, there may be provided a depth extracting method and a depth extracting camera system aligning a plurality of images by performing software image processing in a process of calculating a focus measure ratio between a plurality of images.

Also, according to example embodiments, there may be provided a depth extracting method and a depth extracting camera system having low manufacturing cost compared to a technology aligning through a hardware structure in case that a plurality of images is unaligned.

Also, according to example embodiments, there may be provided a depth extracting method and a depth extracting camera system creating a depth map in a video by acquiring sequentially a plurality of images with a video frame unit and extracting depth for a subject with the video frame unit.

Also, according to example embodiments, there may be provided a depth extracting method and a depth extracting camera system requiring no additional hardware for extracting depth because it is applicable to most of the existing camera system applied a variable focusing lens without any structure change.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates an example of describing a depth extracting method using a focus measure ratio in a depth extracting camera system according to an example embodiment;

FIG. 2 illustrates an example of describing a process calculating a focus measure ratio between a plurality of images according to an example embodiment;

FIG. 3 illustrates an example of specifically describing a process calculating a focus measure ratio between a plurality of images of FIG. 2.

FIG. 4 illustrates an example of describing a process aligning a plurality of images according to an example embodiment;

FIG. 5 illustrates an example of describing a process creating a depth map in a video according to an example embodiment;

FIG. 6 is a flowchart illustrating a depth extracting method using a focus measure ratio in a depth extracting camera system according to an example embodiment;

FIG. 7 is a block diagram illustrating a depth extracting camera system using a focus measure ratio according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

Also, terminologies used herein refer to terms used to appropriately represent the example embodiments and may vary based on a reader, the intent of an operator, or custom of a field to which this disclosure belongs, and the like. Accordingly, the definition of the terms should be made based on the overall description of the present specification.

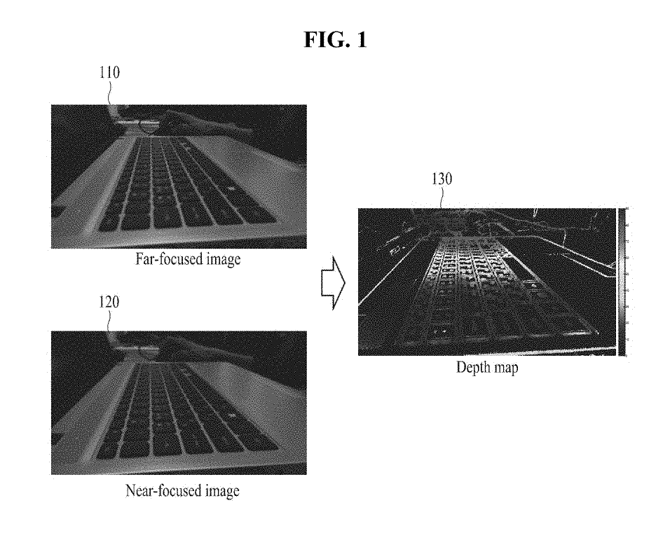

FIG. 1 illustrates an example of describing a depth extracting method using a focus measure ratio in a depth extracting camera system according to an example embodiment;

Referring to FIG. 1, the depth extracting camera system extracts depth for a subject by using a focus measure ratio between a plurality of images having different focused subject distances. Hereinafter, although a case that the number of a plurality of images is two is described, it is not limited or defined to thereto, and the number may be three or more.

In detail, the depth extracting camera system may acquire a first image 110 having a far-focused subject distance and a second image 120 having a near-focused subject distance, may calculate a focus measure ratio between the first image 110 and the second image 120, and may create a depth map 130 in the image including depth for a subject by extracting depth for a subject based on the focus measure ratio between the first image 110 and the second image 120.

Hereinafter, the first image 110 having a far-focused subject distance and the second image 120 having a near-focused subject distance mean respectively an image focused at relatively far and near positions on the basis of the depth camera system.

Each of the first image 110 having a far-focused subject distance and the second image 120 having a close-focused subject distance may be acquired as positions of an optical system or an image sensor included in the depth extracting camera system are changed relatively to each other. However, it is not limited or defined to thereto, and the first image 110 and the second image 120 may be acquired in various ways to have different focused subject distances.

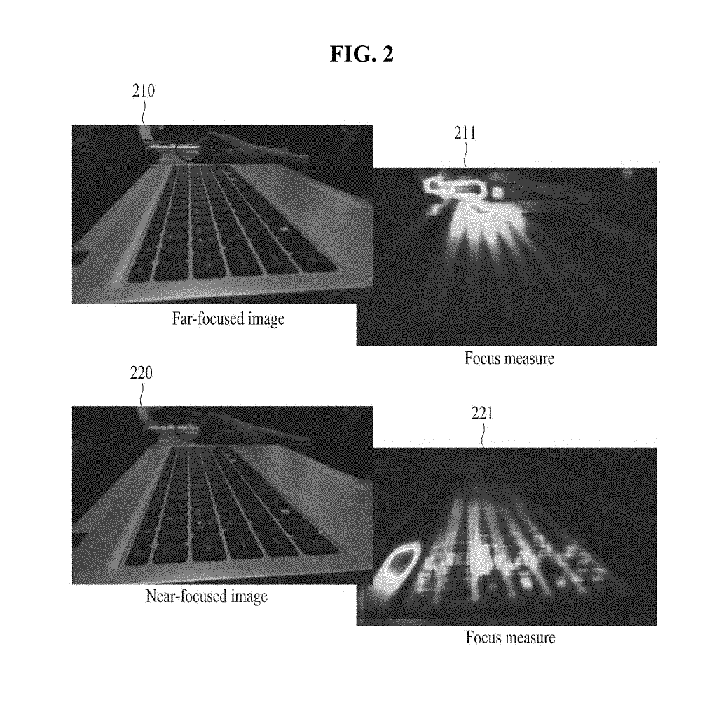

Here, the focus measure ratio between the first image 110 and the second image 120 may be calculated based on a focus measure which is a parameter indicating how sharp the first image 110 and the second image 120 are. A further description related thereto will be made with reference to FIG. 2.

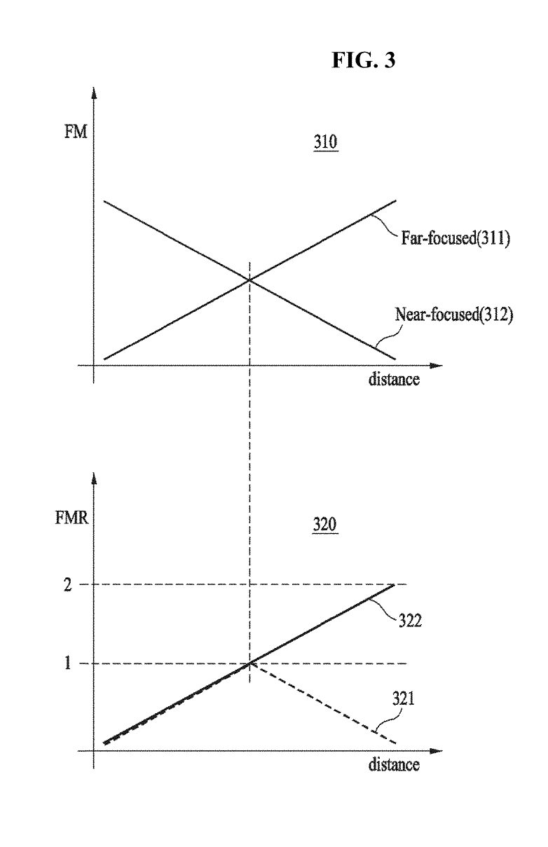

In particular, the focus measure ratio between the first image 110 and the second image 120 may be calculated to distinguish far-near of the focused subject distance of each of the first image 110 and the second image 120 in order to be used in the process of extracting depth for the subject. A further description related thereto will be made with reference to FIG. 3.

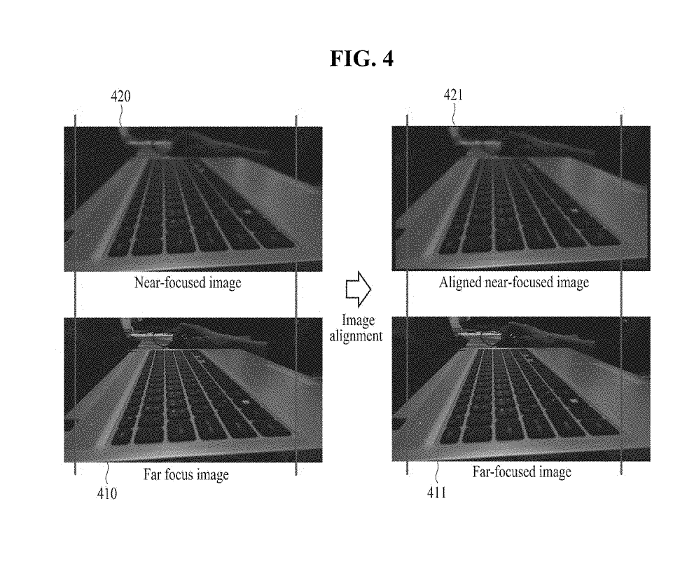

Also, in the case that the first image 110 and the second image 120 are unaligned (for example, in the case that the sizes of the first image 110 and the second image 120 are different each other, or there are offsets in the positions of the subjects included in the first image 110 and the second image 120), the depth extracting camera system may align the first image 110 and the second image 120 through software image processing, may calculate a focus measure ratio between the first image 110 and the second image 120, and may reduce errors of the focus measure ratio between the first image 110 and the second image 120. A further description related thereto will be made with reference to FIG. 4.

Here, in the depth extracting process based on the focus measure ratio between the first image 110 and the second image 120, the depth extracting camera system may use various depth extracting algorithms extracting depth for a subject according to the sharpness between the two images. For example, as the depth extracting algorithms, not only an algorithm extracting depth corresponding to the sharpness between the two images based on PSF (Point Spread Function) but also an algorithm directly calculating depth based on the sharpness between two images may be used. A detailed description related thereto will be omitted because it is beyond the technical idea of the present invention.

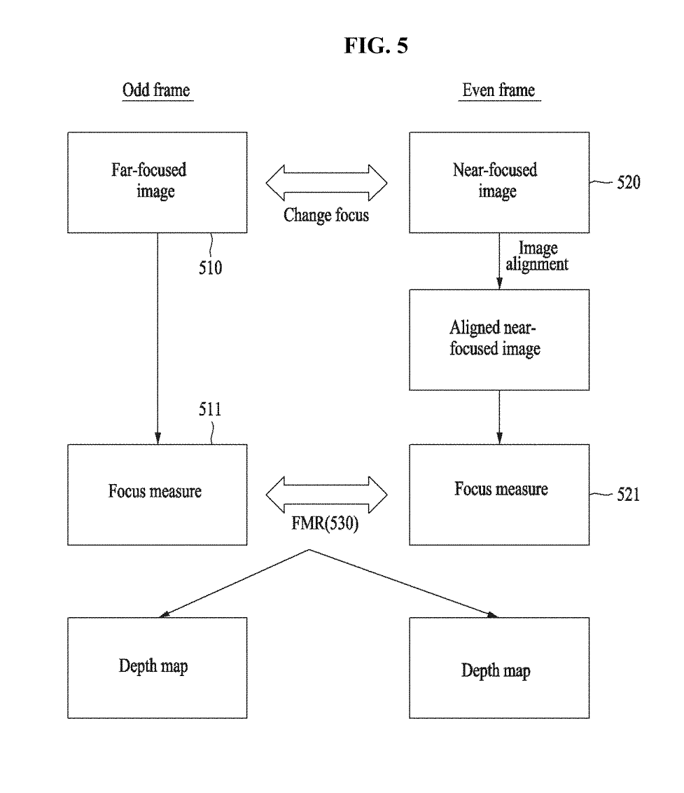

Also, as described above, the depth extracting camera system may extract depth for a subject in a still image based on the first image 110 and the second image 120 as still images, may acquire the first image 110 and the second image 120 with a video frame unit and extract depth for a subject with the frame unit, and may create a depth map in the video. A further description related thereto will be made with reference to FIG. 5.

The depth extracting camera system may extract depth for a subject by using the focus measure ratio between the plurality of images 110, 120 having different focused subject distances, and may reduce a complexity of a depth calculation and improve an accuracy of depth extracting compared to the existing depth extracting method.

FIG. 2 illustrates an example of describing a process calculating a focus measure ratio between a plurality of images according to an example embodiment and FIG. 3 illustrates specifically an example of describing a process calculating a focus measure ratio between a plurality of images of FIG. 2.

Referring to FIGS. 2 and 3, the depth camera system may measure focus measures 211, 221 of each of a plurality of images (hereinafter, a first image 210 having a far-focused subject distance and a second image 220 having a close-focused subject distance) and may calculate a focus measure ratio between the first image 210 and the second image 220 based on the focus measures 211, 221 of each of the first image 210 and the second image 220.

Here, the relation between the focus measure 211 of the first image 210 which is a parameter indicating how sharp the first image 210 is and the focus measure 221 of the second image 220 which is a parameter indicating how sharp the second image 220 is the same with a first graph 310 of FIG. 3. Referring to the first graph 310, it may be seen that the focus measure 211 of the first image 210 (a first graph line 311) increases as the focused subject distance is far, and the focus measure 221 of the second image 220 (a second graph line 312) decreases as the focused subject distance is far.

Accordingly, the depth extracting camera system may calculate a relative ratio between the focus measure 211 of the first image 210 and the focus measure 221 of the second image 220 with the focus measure ratio between the first image 210 and the second image 220.

For example, the depth extracting camera system may calculate the focus measure ratio between the first image 210 and the second image 220 by using a minimum value of the relative ratio between the focus measure 211 of the first image 210 and the focus measure 221 of the second image 220 and a maximum value of the relative ratio between the focus measure 211 of the first image 210 and the focus measure 221 of the second image 220 like Equation 1 below.

$${FM}_{ratio} ( x , y ) = \frac{\begin{matrix}min ( {FM}_{far - focused} ( x , y ) , \\ {FM}_{near - focused} ( x , y ) )\end{matrix}}{\begin{matrix}max ( {FM}_{far - focused} ( x , y ) , \\ {FM}_{near - focused} ( x , y ) )\end{matrix}} \qquad 〈 Equation 1 〉$$

In Equation 1, FMᵣₐₜᵢₒ(x,y) indicates the focus measure ratio between the first image 210 and the second image 220 having (x, y) coordinates, FM_{far-focused}(x,y) indicates the focus measure 211 of the first image 210 having a far-focused subject distance, and FM_{near-focused}(x,y) indicates the focus measure 221 of the second image 220 having a close-focused subject distance.

Here, in the case of calculating the focus measure ratio between the first image 210 and the second image 220 with only Equation 1, because the focus measure ratio between the first image 210 and the second image 220 has a value of between 0 to 1 like the first graph line 321 of the second graph 320 of FIG. 3, far-near of the focused subject distance of each of the first image 210 and the second image 220 may not be distinguished.

Accordingly, the depth extracting camera system may calculate the focus measure ratio between the first image 210 and the second image 220 with a value of between 0 to 2 to distinguish far-near of the focused subject distance of each of the first image 210 and the second image 220 like a second graph line 322 of a second graph 320 based on Equation 2.

<Equation 2>

FM′ᵣₐₜᵢₒ(x,y)=2−FMᵣₐₜᵢₒ(x,y), if FM_{far-focused}(x,y)≧FM_{near-focused}(x,y)

In Equation 2, FMᵣₐₜᵢₒ(x,y) indicates the focus measure ratio between the first image 210 and the second image 220 having (x, y) coordinates, FM′ᵣₐₜᵢₒ(x,y) indicates the focus measure ratio between the first image 210 and the second image 220 being calculated to distinguish the far-near of the focused subject distance of each of the first image 210 and the second image 220, FM_{far-focused}(x,y) indicates the focus measure 211 of the first image 210 having a far-focused subject distance, and FM_{near-focused}(x,y) indicates the focus measure 221 of the second image 220 having a close-focused subject distance.

In detail, according to Equation 2, in a section that the focus measure 211 of the first image 210 is bigger than the focus measure 221 of the second image 220, the depth extracting camera system may calculate a focus measure ratio between the first image 210 and the second image 220 reflected the far-near of the focused subject distance of each of the first image 210 and the second image 220 by subtracting the focus measure ratio between the first image 210 and the second image 220 calculated with Equation 1 from Equation 2.

The focus measure ratio between the first image 210 and the second image 220 reflected the far-near of the focused subject distance of each of the first image 210 and the second image 220 may be used in the process of depth extracting described referring to FIG. 1. Accordingly, the depth extracting camera system may accurately extract depth for a subject based on the focus measure ratio between the first image 210 and the second image 220 reflected the far-near of the focused subject distance of each of the first image 210 and the second image 220.

FIG. 4 illustrates an example of describing a process aligning a plurality of images according to an example embodiment.

Referring to FIG. 4, before the process of calculating a focus measure ratio between a first image 410 and a second image 420 described referring FIGS. 2 and 3, the depth extracting camera system may align the first image 410 and the second image 420 based on an alignment parameter. In detail, the depth camera system may align the second image 420 on the basis of the first image 410, may calculate the focus measure ratio between the first image 411 and the aligned second image 421 based on the first image 411 and the aligned second image 421, and may reduce errors of the focus measure ratio.

Here, although a case of aligning the second image 420 on the basis of the first image 410 is illustrated in the FIG., it is not limited or defined to thereto, and the first image 410 may be aligned on the basis of the second image 420 or all of the first image 410 and the second image 420 may be aligned on the basis of a specific reference value.

Here, the alignment parameter, as a parameter relating to image resize and/or image position offset, may reflect characteristics according to the depth extracting camera system model. For example, before performing the depth extracting process, the depth extracting camera system may acquire at least two sample images having different focused subject distances and match them and may estimate the alignment parameter based on the result.

Also, the depth extracting camera system may improve a reliability of the alignment parameter by repeatedly performing operations estimating the alignment parameter.

Here, the process of aligning the first image 410 and the second image 420 may be selectively performed only if the first image 410 and the second image 420 are unaligned instead of unconditionally being performed.

Also, although a case that the alignment parameter is estimated in advance based on the at least two sample images having different focused subject distances acquired before performing the depth extracting process is described, it is not limited or defined to thereto, and in the case that the depth extracting process is performed for a video, the alignment parameter may be estimated based on a plurality of images having different focused subject distances (the images being subjects of the depth extracting process) acquired first in the depth extracting process.

Because the depth extracting camera system performs software image processing aligning by the alignment parameter in the case that the first image 410 and the second image 420 are unaligned, the depth extracting camera system may have a low manufacturing cost compared to a technology aligning images through a hardware structure.

FIG. 5 illustrates an example of describing a process creating a depth map in a video according to an example embodiment.

Referring to FIG. 5, the depth extracting camera system may create a depth map by performing depth extracting in a video as well as depth extracting for a subject in a still image.

For example, during a video recording process, the depth extracting camera system may acquire a first image 510 having a far-focused subject distance and measure a focus measure 511 of the first image 510 in odd frame, may acquire a second image 520 having a close-focused subject distance and measure a focus measure 521 of the second image 520 in even frame, and may calculate a focus measure ratio 530 between the first image 510 and the second image 520 based on the focus measure 511 of the first image 510 and the focus measure 521 of the second image 520. Accordingly, the depth extracting camera system may extract depth for the subject in each of the odd frame and the even frame. Hereinafter, although a case that the first image 510 having a far-focused subject distance is acquired in the odd frame and the second image 520 having a close-focused subject distance is acquired in the even frame is described, it is not limited or defined to thereto, and each of a plurality of images having different focused subject distances may be variously acquired in respectively the odd frame and the even frame.

Here, a process of calculating the focus measure ratio 530 between the first image 510 and the second image 520 based on the focus measure 511 of the first image 510 and the focus measure 521 of the second image 520 may be performed as the same with the process described referring to FIGS. 2 and 3.

Also, before calculating the focus measure ratio 530 between the first image 510 and the second image 520, the depth extracting camera system may perform the image aligning process described referring to FIG. 4.

Although a case that after the second image 520 is acquired in even frame, the second image 520 is aligned on the basis of the first image 510 is illustrated in the FIG., it is not limited or defined to thereto, and the first image 510 may be aligned on the basis of the second image 520 or all of the first image 510 and the second image 520 may be aligned on the basis of a specific reference value.

The depth extracting camera system may create a depth map in a video by repeatedly performing the operations for all of odd frame and even frame during the video recording.

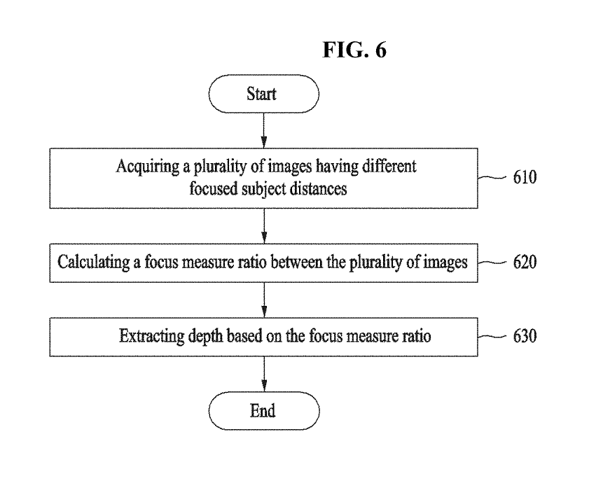

FIG. 6 is a flowchart illustrating a depth extracting method using a focus measure ratio in a depth extracting camera system according to an example embodiment.

Referring to FIG. 6, the depth extracting method is performed by the depth extracting camera system. Also, the depth extracting camera system may be implemented in the form of a computer program stored in a medium to implement the depth extracting method in conjunction with a computer implementing an electronic device as well as hardware modules.

The depth extracting camera system acquires a plurality of images—each of the plurality of images including a subject—having different focused subject distances 610.

Then, the depth extracting camera system calculates a focus measure ratio between the plurality of images 620.

In detail, in operation 620, the depth extracting camera system may measure focus measures of each of the plurality of images and may calculate a focus measure ratio between the plurality of images based on the focus measures of each of the plurality of images.

In particular, in operation 620, the depth extracting camera system may calculate the focus measure ratio between the plurality of images to distinguish far-near of the focused subject distance of each of the plurality of images. For example, the depth extracting camera system may calculate the focus measure ratio with a value of between 0 to 2 to distinguish far-near of the focused subject distance of each of the plurality of images.

Then, the depth extracting camera system extracts depth for a subject based on the focus measure ratio between the plurality of images 630.

Because the focus measure ratio is calculated to distinguish far-near of the focused subject distance of each of the plurality of images in operation 620, the depth extracting camera system may extract depth for a subject based on the focus measure ratio between the plurality of images reflected the far-near of the focused subject distance of each of the plurality of images in operation 630.

Here, in operation 630, the depth extracting camera system may align the plurality of images based on an alignment parameter and may calculate a focus measure ratio between the aligned plurality of images.

Here, the alignment parameter may be estimated based on the result of matching at least two images having different focused subject distances of the depth extracting camera system.

Also, the depth extracting camera system may extract depth in a video as well as extract depth for a subject in a still image. In this case, the depth extracting camera system may sequentially acquire the plurality of images with a video frame unit in operation 610 and may extract depth for a subject with the video frame unit in operation 630.

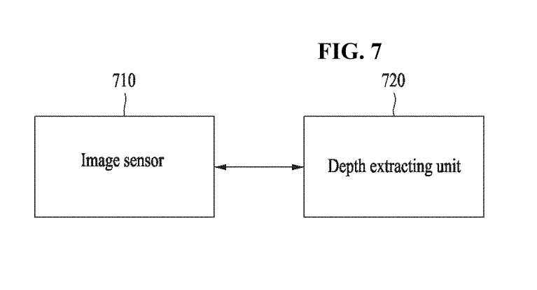

FIG. 7 is a block diagram illustrating a depth extracting camera system using a focus measure ratio according to an example embodiment.

Referring to FIG. 7, the depth extracting camera system includes an image sensor 710 and a depth extracting unit 720.

The image sensor 710 acquires a plurality of images—each of the plurality images including a subject—having different focused subject distances.

The depth extracting unit 720 calculates a focus measure ratio between the plurality of images and extracts depth for the subject based on the focus measure ratio between the plurality of images.

Here, the depth extracting unit 720 may measure focus measures of each of the plurality of images and may calculate the focus measure ratio between the plurality of images based on the focus measures of each of the plurality of images.

In particular, the depth extracting unit 720 may calculate the focus measure ratio between the plurality of images to distinguish far-near of the focused subject distance of each of the plurality of images. For example, the depth extracting unit 720 may calculate the focus measure ratio between the plurality of images with a value of between 0 to 2 to distinguish far-near of the focused subject distance of each of the plurality of images.

Because the focus measure ratio is calculated to distinguish far-near of the focused subject distance of each of the plurality of images, the depth extracting unit 720 may calculate depth for the subject based on the focus measure ratio between the plurality of images reflected the far-near of the focused subject distance of each of the plurality of images.

Also, the depth extracting unit 720 may align the plurality of images based on an alignment parameter and may calculate a focus measure ratio between the aligned plurality of images.

Here, the alignment parameter may be estimated based on a result of matching at least two images having different focused subject distances.

Also, the depth extracting unit 720 may extract depth in a video as well as extract depth for a subject in a still image. In this case, the image sensor 710 may sequentially acquire a plurality of images with a video frame unit of the depth extracting camera system, and the depth extracting unit 720 may extract depth for a subject with the video frame unit.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A depth extracting method using a focus measure ratio in a depth extracting camera system, wherein the method comprises:
acquiring a plurality of images—each of the plurality of images including a subject—having different focused subject distances;
calculating a focus measure ratio between the plurality of images; and
extracting depth for the subject based on the focus measure ratio between the plurality of images.

2. The depth extracting method of claim 1, wherein the calculating a focus measure ratio is configured to calculate a focus measure ratio between the plurality of images to distinguish far-near of the focused subject distance of each of the plurality of images.

3. The depth extracting method of claim 1, wherein the calculating a focus measure ratio is configured to calculate a focus measure ratio between the plurality of images to a value of between 0 to 2 to distinguish far-near of the focused subject distance of each of the plurality of images.

4. The depth extracting method of claim 2, wherein the extracting depth for the subject based on the focus measure ratio between the plurality of images is configured to extract depth for the subject based on the focus measure ratio between the plurality of images reflected the far-near of the focused subject distance of each of the plurality of images.

5. The depth extracting method of claim 1, the calculating a focus measure ratio between the plurality of images comprises:
aligning the plurality of images based on an alignment parameter; and
calculating a focus measure ratio between the aligned plurality of images.

6. The depth extracting method of claim 5, wherein the alignment parameter is configured to be estimated based on a result of matching at least two or more images having different subject distances of the depth extracting camera system.

7. The depth extracting method of claim 1, wherein the calculating a focus measure ratio between the plurality of images comprises:
measuring focus measures of each of the plurality of images; and
calculating a focus measure ratio between the plurality of images based on the focus measures of each of the plurality of images.

8. The depth extracting method of claim 1, wherein the acquiring a plurality of images having different focused subject distances comprises acquiring sequentially the plurality of images with a video frame unit of the depth extracting camera system,
wherein the extracting a depth for the subject based on the focus measure ratio between the plurality of images comprises extracting depth for the subject with the video frame unit.

9. A computer program stored in a medium to implement an depth extracting method using a focus measure ratio in conjunction with a computer implementing an electric device, wherein the method comprises:
acquiring a plurality of images—each of the plurality of images including a subject—having different focused subject distances;
calculating a focus measure ratio between the plurality of images; and
extracting depth for the subject based on the focus measure ratio between the plurality of images.

10. The computer program of claim 9, wherein the calculating a focus measure ratio between the plurality of images is configured to calculate a focus measure ratio between the plurality of images to distinguish far-near of the focused subject distance of each of the plurality of images.

11. The computer program of claim 10, wherein the extracting depth for the subject based on the focus measure ratio between the plurality of images is configured to extract depth for the subject based on the focus measure ratio between the plurality of images reflected the far-near of the focused subject distance of each of the plurality of images.

12. A depth extracting camera system using a focus measure ratio, wherein the system comprises:
an image sensor acquiring a plurality of images—each of the plurality of images including a subject—having different focused subject distances;
a depth extracting unit calculating a focus measure ratio between the plurality of images and extracting depth for the subject based on the focus measure ratio between the plurality of images.

13. The depth extracting camera system of claim 12, wherein the depth extracting unit is configured to calculate a focus measure ratio between the plurality of images to distinguish far-near of the focused subject distance of each of the plurality of images.

14. The depth extracting camera system of claim 12, wherein the depth extracting unit is configured to align the plurality of images based on an alignment parameter and to calculate a focus measure ratio between the aligned plurality of images.

15. The depth extracting camera system of claim 12, wherein the image sensor is configured to acquire sequentially the plurality of images with a video frame unit of the depth extracting camera system,
wherein the depth extracting unit is configured to extract depth for the subject with the video frame unit.
